(19) United States
(12) Patent Application Publication
(10) Pub. No.: US 2012/0163312 A1
(43) Pub. Date: Jun. 28, 2012

(54) Reducing the Number of Silencing Frames Transmitted in a Coexistence Network

(75) Inventors: Ariton E. Xhafa, Plano, TX (US); Yanjun Sun, Richardson, TX (US); Josef Peery, Ra'anana (IL); Assaf Sella, Rishpon (IL); Xiaolin Lu, Plano, TX (US)

(73) Assignee: Texas Instruments Incorporated, Dallas, TX (US)

(21) Appl. No.: 13/333,440

(22) Filed: Dec. 21, 2011

Related U.S. Application Data
(60) Provisional application No. 61/426,606, filed on Dec. 23, 2010.

(51) Int. Cl. H04W 72/04

(52) U.S. Cl. 370/329

(57) ABSTRACT

Systems and methods for reducing the number of silencing frames transmitted in a coexistence network are described. In some embodiments, a method may include abstaining from transmitting silencing frames until detection of a predetermined event. Predetermined events include, for example, detection of a retransmitted packet, detection of a transmission or packet rate drop, and/or detection that an expected packet has been missed. In some cases, two or more predetermined events may be logically combined in any suitable manner or order, and may occur in series or in parallel with respect to each other. Once the predetermined event(s) have been detected, a silencing frame may then be transmitted. In some cases, subsequent silencing frames may be transmitted to facilitate return to a maximum attainable transmission rate. An investigation or observation period during which silencing frames are transmitted despite the absence of a predetermined event may enable the collection of network statistics.

### CROSS-REFERENCE TO RELATED APPLICATION

This application claims the benefit of the filing date of U.S. Provisional Patent Application No. 61/426,606, which is titled “Method for Reducing Medium Contamination” and was filed on Dec. 23, 2010, the disclosure of which is hereby incorporated by reference herein in its entirety.

### TECHNICAL FIELD

Embodiments are directed, in general, to coexistence networks, and, more specifically, to systems and methods for reducing the number of silencing frames transmitted in a coexistence network.

### BACKGROUND

Next-generation mobile devices will soon be able to communicate using different wireless network technologies. Examples of such technologies include, but are not limited to, Worldwide Interoperability for Microwave Access (WiMAX), WiFi, Long Term Evolution (LTE) mobile telephony, Wireless Local Area Networks (WLANs), Personal Area Networks (PANs), wireless Universal Serial Bus (USB), BLUETOOTH (BT), etc.

While increased access to these technologies is expected to benefit users and operators alike, the inventors hereof have recognized that interference can become a problem, particularly when two dissimilar interfaces operate concurrently onboard a single device. For example, as illustrated in FIG. 1, WLAN (2.4-2.5 GHz), BT (2.4-2.4835 GHz) and WiMAX (2.3-2.4 GHz and 2.5-2.7 GHz), operate at relatively close and, in some cases, overlapping frequency bands with respect to each other—so close, in fact, that the out-of-band emission by either technology may saturate the receiver of the other technology, thus resulting in potential blocking and/or Quality-of-Service (QoS) degradation. More generally, interference between any two technologies operating in the same device can potentially create challenges with respect to the coexistence of corresponding wireless interfaces on that device.

### SUMMARY

Systems and methods for reducing the number of silencing frames transmitted in a coexistence network are described. A single wireless computing or networking device may include dissimilar wireless interfaces. To enable coexistence among the two or more interfaces, such a device will typically transmit silencing frames every time it switches operation from one interface to another. As discussed herein, however, the inventors hereof have discovered that the transmission of silencing frames in connection with each switching operation may not always be necessary. In some implementations, by reducing the number of silencing frames transmitted by a given coexistence node, various systems and methods described herein may enable increased throughput for other devices in the same network while maintaining high throughput levels at that node.

In an illustrative, non-limiting embodiment, a method may include receiving a packet over a first interface, determining that the received packet is a retransmitted packet, and transmitting a silencing frame in response to the determination. The silencing frame may be configured to reserve a frequency band for a specified time, the specified time beginning prior to the wireless device switching operation from the first interface to a second interface dissimilar from the first interface, and the specified time ending when the wireless device switches operation back to the first interface.

The method may also include, prior to receiving the packet over the first interface, abstaining or refraining from transmitting one or more silencing frames. Additionally or alternatively, the method may include, prior to receiving the packet over the first interface, switching operation between the first and second interfaces at least once without transmitting one or more silencing frames. In some implementations, the silencing frame may include a clear-to-send (CTS)-to-self frame. In some cases, the silencing frame may also include a trigger frame following the CTS-to-self frame. Moreover, the frequency band may span a frequency of operation of the first interface, a frequency of operation of the second interface, and/or any combination thereof.

The method may further include determining that a specified transmission rate between an access point and the wireless device has not been achieved, and transmitting another silencing frame prior to the wireless device switching operation from the first interface to the second interface in response to the latter determination. For example, the specified transmission rate may be calculated based, at least in part, upon packet arrival rates obtained by the wireless device when transmitting silencing frames.

In another illustrative, non-limiting embodiment, another method may include receiving a first packet over a first interface and determining that a transmission rate has been reduced based, at least in part, upon the first packet. The method may then include transmitting a silencing frame in response to the determination, the silencing frame configured to reserve a frequency band for a specified time, the specified time beginning prior to the wireless device switching operation from the first interface to a second interface dissimilar from the first interface, the specified time ending when the wireless device switches operation back to the first interface

In yet another illustrative, non-limiting embodiment, another method may include calculating a time when a first packet is expected to be received over a first interface and determining that the first packet has not been received by the expected time. The method may the include transmitting a silencing frame in response to the determination, the silencing frame configured to reserve a frequency band for a specified time, the specified time beginning prior to the wireless device switching operation from the first interface to a second interface dissimilar from the first interface, the specified time ending when the wireless device switches operation back to the first interface.

In various implementations, one or more wireless computing or networking devices may perform one or more of the methods described herein. In other implementations, a tangible electronic storage medium may have program instructions stored thereon that, upon execution by a processor, cause one or more wireless computing or networking devices to perform one or more operations disclosed herein. Examples of such a processor include, but are not limited to, a central processor unit (CPU), a main processing unit (MPU), a digital signal processor (DSP), an application specific integrated circuit (ASIC), a system-on-chip (SoC) circuit, a field-programmable gate array (FPGA), a programmable logic device (PLD), a field programmable logic device (FPLD), an advanced reduced instruction set computing (RISC) machine (ARM) processor, a microprocessor, or a microcontroller. In yet other implementations, a wireless computing or networking device may include at least one processor and a memory coupled to the at least one processor, the memory configured to store program instructions executable by the at least one processor to cause the wireless computing or networking device to perform one or more operations disclosed herein.

### BRIEF DESCRIPTION OF THE DRAWINGS

Reference will now be made to the accompanying drawings, wherein:

FIG. 1 is a spectral graph illustrative of different prior art technologies and their operating bands.

FIG. 2 is a diagram of a wireless local area network (WLAN) with an access point and a plurality of wireless devices/stations according to some embodiments.

FIG. 3 is a block diagram of an access point and/or wireless device according to some embodiments.

FIG. 4 is a block diagram of a wireless device according to some embodiments.

FIG. 5 is a timing diagram comparing times for sending silencing frames upon detection of a predetermined event according to some embodiments.

FIG. 6 is a flowchart of a method of communicating according to some embodiments.

FIG. 7 is a flowchart of a method of determining a silencing frame transmission time according to some embodiments.

FIG. 8 is a flowchart of another method of determining a silencing frame transmission time according to some embodiments.

FIG. 9 is a flowchart of a method of reducing a number of silencing frames transmitted in a coexistence network according to some embodiments.

FIG. 10 is a flowchart of another method of reducing a number of silencing frames transmitted in a coexistence network according to some embodiments.

FIG. 11 is a flowchart of yet another method of reducing a number of silencing frames transmitted in a coexistence network according to some embodiments.

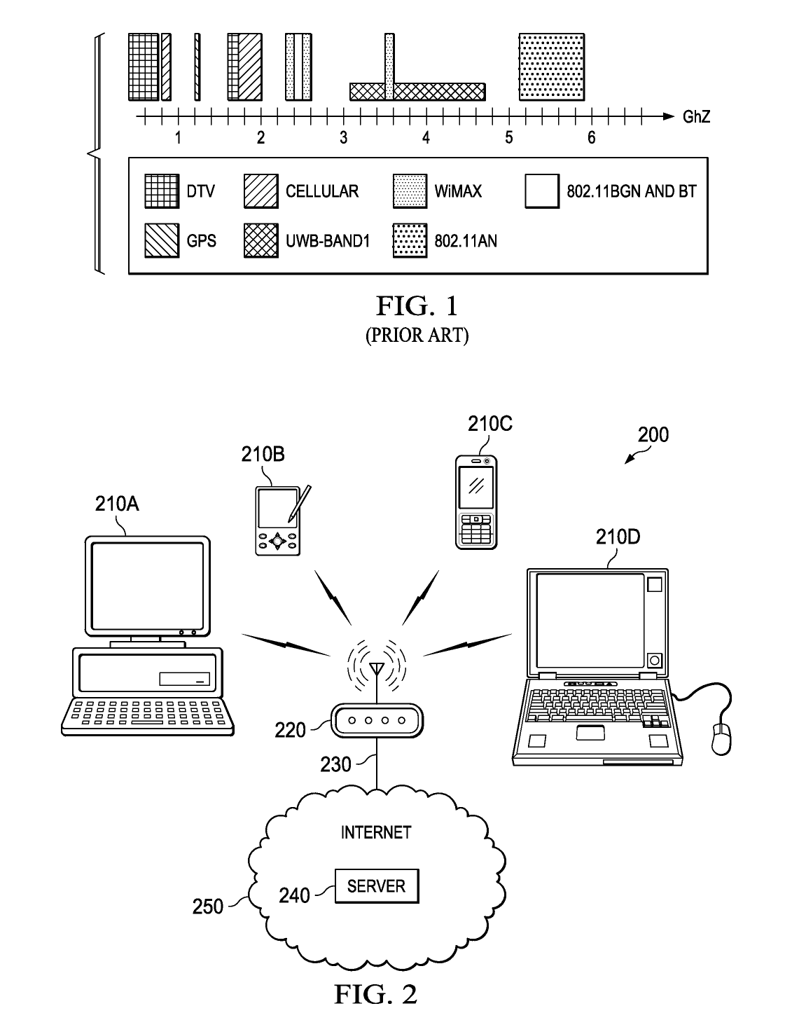

### DETAILED DESCRIPTION

Certain terms are used throughout the following description and claims to refer to particular system components. As a person of ordinary skill in the art will appreciate, computer companies may refer to a component by different names. This document does not intend to distinguish between components that differ in name but not operation. In the following discussion and in the claims, the terms “including” and “comprising” are used in an open-ended fashion, and thus should be interpreted to mean “including, but not limited to.” Also, the term “couple” or “couples” is intended to mean either an indirect or direct electrical connection. Thus, if a first device couples to a second device, that connection may be through a direct electrical connection, or through an indirect electrical connection via other devices and connections (e.g., wired or wireless connections). The term “system” refers to a collection of two or more hardware and/or software components, and may be used to refer to an electronic device or devices or a sub-system thereof. Further, the term “software” includes any executable code capable of running on a processor, regardless of the media used to store the software. Thus, code stored in non-volatile memory, and sometimes referred to as “embedded firmware,” is included within the definition of software.

The invention(s) now will be described more fully hereinafter with reference to the accompanying drawings. The invention(s) may, however, be embodied in many different forms and should not be construed as limited to the embodiments set forth herein. Rather, these embodiments are provided so that this disclosure will be thorough and complete, and will fully convey the scope of the invention(s) to a person of ordinary skill in the art. A person of ordinary skill in the art may be able to use the various embodiments of the invention(s).

It should be understood at the outset that although exemplary implementations of embodiments of the disclosure are illustrated below, embodiments may be implemented using any number of techniques, whether currently known or in existence. This disclosure should in no way be limited to the exemplary implementations, drawings, and techniques illustrated below, including the exemplary design and implementation illustrated and described herein, but may be modified within the scope of the appended claims along with their full scope of equivalents.

In working toward solving the coexistence problem, especially when WLAN technology is one of a plurality of network technology subsystems operating in a same device (i.e., onboard network technology subsystems), time-multiplexed operation among the onboard network technology subsystems is useful. For example, and not by way of limitation, in the case of WLAN and BT coexistence, BT voice calls may have priority over other traffic flows in a WLAN. As part of time-multiplexed operation in such exemplary device, during the time periods that the device operates in active BT mode, the WLAN services on the same device may operate in unscheduled automatic power saving delivery (U-APSD) mode. When the device switches to operate in active WLAN mode, the device may send a trigger frame (or a PS-Poll) to the access point (AP) indicating that the device is ready to act as a receiver (e.g., to receive packets of information). The AP may also be referred to herein as a transmitter (e.g., a transmitter of data packets). For the sake of discussion, assume the transmitted packets of information (normally containing data) are correctly routed to the device as the intended recipient. Transmission becomes problematic if the packets addressed to the device are sent by the AP within the time period that the device is operating in active WLAN mode but the device has insufficient time to reply with an acknowledgement frame or packet (ACK) because, for example, the device has switched back to active BT mode (e.g., incoming voice data) and misses the packet transmitted by the AP. As a result, the device may not send an ACK, as expected. As a further example, if the packets sent by the AP are not sent within the time interval that the device is operating in active WLAN mode, again the device would not be able to send an ACK.

When the AP fails to receive an ACK from its intended recipient device, a transmission rate-fall back mechanism commences at the AP. This mechanism reduces the transmission rate used to send subsequent packets from the AP to the device based on the failure to receive an ACK from the STA. In other words, when the AP transmits a packet to the intended device—also referred to herein as a “station” (STA or STA)—and the AP receives no corresponding ACK from that STA, then the AP reduces the current transmission rate to a lower (slower) transmission rate because it assumes the communication channel between itself and the intended STA is bad.

Although the packet size does not change, as the transmission rate decreases, the total duration of the packet lengthens, which in turn results in an increased probability that the duration of the AP wireless transmission and the time the device is involved with a BT reception will time-wise overlap. Worse, as the packets transmitted over the channel medium occupy ever-lengthening intervals, the corresponding probability of a collision (time-wise overlapping) with the use by the device/STA of the medium on behalf of a different network technology subsystem (in the present example, in active BT mode), quickly increases. With the increased probability of collisions comes increased likelihood of the AP more often failing to receive an ACK, and in response continuing to lower the transmission rate, thereby increasing the duration of the transmission of the packet and, naturally, increasing the probability of a further collision such that the STA fails (again) to receive the packet, and fails (again) to send an ACK. It can be appreciated that, as this cycle proceeds, performance of the device STA rapidly deteriorates.

This phenomenon can be undesirable for many reasons, including, for example, the potential violation of QoS (quality of service) requirements. Another reason stems from the practice of an AP to continue reducing the transmission rate until reaching a predetermined threshold, at which time the AP may unilaterally disconnect the STA from the network (because the AP would not be able to transfer much if anything at all to the device above that threshold). The rapid deterioration in performance—and associated increase in probability of collision—is what will be referred to herein as an “avalanche effect” because, as time progresses, the message becomes buried and unrecoverable/lost. Simply put, the avalanche effect reflects the phenomenon that the probability of losing a packet, and risk of potentially being unwillingly disconnected from the system, increases as the rate of transmission decreases.

To protect the network from the avalanche effect, certain embodiments described herein may employ a silencing frame. An example of a silencing frame includes, but is not limited to, a clear-to-send-to-self (CTS-to-self or CTS2Self) frame. In these embodiments, before the STA transitions to an active BT mode (i.e., an example of a higher priority network technology), the STA device may send a silencing frame and reserve the medium until the time corresponding to the end of the active BT mode or the end of that BT transmission ends (as the case may be), and the next lower priority network technology (e.g., WLAN, etc.) interval begins.

It has become apparent, however, that the use of silencing frames to protect priority interval transmissions from the avalanche effect in coexisting dissimilar technology subsystem networks can sometimes drastically reduce the throughput of lower priority interval (e.g., WLAN, etc.) transmissions, because STAs/devices must defer (be silent) during the time set by the duration field (NAV) of the silencing frame. Thus, sending the silencing frame too early, results in other STAs/devices in the network (for example, those on the WLAN) having to remain quiet (deferring) for at least the entire BT active mode interval. This early deference, in turn, can result in significantly decreased throughput of the network.

In light of the foregoing, certain embodiments described herein may provide systems and methods to determine a suitable time when to send silencing frames, and hence, improve the overall network throughput while avoiding avalanche effects. Furthermore, the inventors hereof have discovered that the transmission of silencing frames in connection with each switching operation (i.e., from a first wireless interface to a second wireless interface) may not always be necessary. Accordingly, in some embodiments, by reducing the number of silencing frames transmitted by a given coexistence node, various systems and methods described herein may enable increased throughput for other devices in the same network while maintaining high throughput levels at that node.

FIG. 2 illustrates an example wireless local area network (WLAN) 200 with a plurality of wireless computing or networking devices/stations—each referred to individually as a device, station, STA or device/station, and an access point (AP), according to some embodiments. It should be appreciated that the network of FIG. 2 is meant to be illustrative and not meant to be exhaustive; for example, it should be appreciated that more, different or fewer communication systems, devices and/or paths may be used to implement embodiments. To provide wireless data and/or communication services (e.g., telephone services, Internet services, data services, messaging services, instant messaging services, electronic mail (email) services, chat services, video services, audio services, gaming services, etc.), WLAN 200 may include access point (AP) 220 and any of a variety of fixed-location and/or mobile wireless devices or stations (STAs), four of which are respectively designated in FIG. 2 with reference numerals 210A, 210B, 210C, and 210D. Computing or networking devices 210 include any variety of personal computer (PC) 210A with wireless communication capabilities, a personal digital assistant (PDA) 210B or MP3 player, a wireless telephone 210C (e.g., a cellular phone, a Voice over Internet Protocol (VoIP) telephonic functionality, a smart phone, etc.), a laptop computer 210D with wireless communication capabilities, etc. At least one of AP 220 and STAs 210A-D may be implemented in accordance with at least one wired and/or wireless communication standard (e.g., from the IEEE 802.11 family of standards). Further, at least one device 210 may include a plurality of co-existing wireless network technology subsystems onboard the at least one device 210. In at least some embodiments, device 210 may include a WLAN network interface and a BT network interface. For example, the WLAN network may handle File Transfer Protocol (FTP), with Internet file download, and e-mail traffic, whereas the BT network may handle synchronous connection-oriented high-quality voice level 3 (SCO HV3) traffic. As such, in this example, an STA is a WLAN and BT node, and transmissions in different networks may be achieved via a time-duplexing approach (ON/OFF). It will be noted that reference to “STA” (station) may be used herein as a shorthand reference to “STA1”, “device 210” and “device 410” during respective discussions to aid in ease of understanding.

In the example of FIG. 2, to enable the plurality of devices/STAs 210A-D to communicate with devices and/or servers located outside WLAN 200, AP 220 is communicatively coupled via any of a variety of communication paths 230 to, for example, any of a variety of servers 240 associated with public and/or private network(s) such as the Internet 250. Server 240 may be used to provide, receive and/or deliver, for example, any variety of data, video, audio, telephone, gaming, Internet, messaging, electronic mail, etc. service. Additionally or alternatively, WLAN 200 may be communicatively coupled to any of a variety of public, private and/or enterprise communication network(s), computer(s), workstation(s) and/or server(s) to provide any of a variety of voice service(s), data service(s) and/or communication service(s).

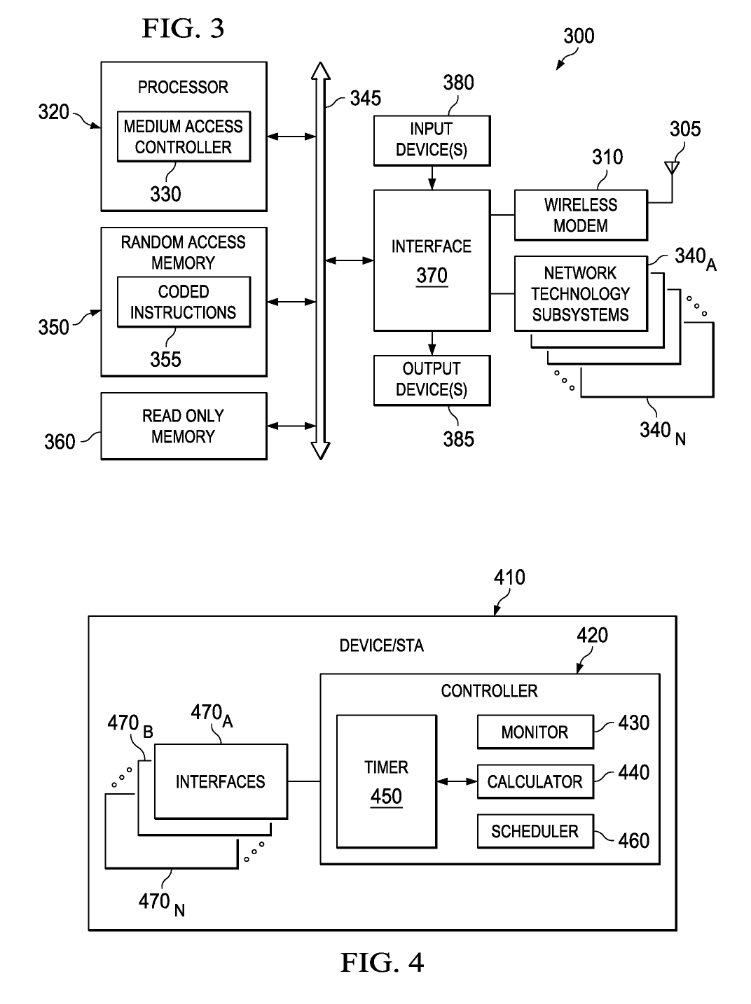

The systems and methods described herein may be implemented on any general-purpose computer with suitable processing power, memory resources, and network throughput capability to handle the necessary workload placed upon it. FIG. 3 illustrates an exemplary, general-purpose computer system configured to implement certain embodiments disclosed herein. In particular, device 300 may be an access point and/or wireless device, according to embodiments. It should be expressly understood that any device on, for example, WLAN 200 or other embodiments, may at times be an access point and at other times be a station. It should also be understood that in some embodiments, there may be at least one dedicated access point, with any number of devices acting as stations.

Device 300 comprises at least one of any of a variety of radio frequency (RF) antennas 305 and any of a variety of wireless modems 310 that support wireless signals, wireless protocols and/or wireless communications (e.g., according to IEEE 802.11n). RF antenna 305 and wireless modem 310 may be configured to receive, demodulate and decode WLAN signals transmitted to and/or within a wireless network. Likewise, wireless modem 310 and RF antenna 305 may be configured to encode, modulate and transmit wireless signals from device 300 to and/or within a wireless network. Thus, RF antenna 305 and wireless modem 310 collectively implement a “physical layer” (PHY) for device 300. It should be appreciated that device 300 is communicatively coupled to at least one other device and/or network (e.g., a local area network (LAN), the Internet 250, etc.). It should further be understood that illustrated antenna 305 represents one or more antennas, while the illustrated wireless modem 310 represents one or more wireless modems.

Device 300 further comprises processor(s) 320. It should be appreciated that processor 320 may be at least one of a variety of processors such as, for example, a microprocessor, a microcontroller, a central processor unit (CPU), a main processing unit (MPU), a digital signal processor (DSP), an application specific integrated circuit (ASIC), a system-on-chip (SoC) circuit, a field-programmable gate array (FPGA), a programmable logic device (PLD), a field programmable logic device (FPLD), an advanced reduced instruction set computing (RISC) machine (ARM) processor, a microprocessor, or a microcontroller. Processor 320 may be configured to execute coded instructions 355, which may be coupled to processor 320 (e.g., within a random-access memory (RAM) 350) and/or within an on-board memory of the processor 320. Processor 320 communicates with memory (including RAM 350 and read-only memory (ROM) 360) via bus 345. RAM 350 may be implemented by DRAM, SDRAM, and/or any other type of RAM device, whereas ROM 360 may be implemented by flash memory and/or any other type of memory device.

Processor 320 may implement MAC 330 using one or more of any of a variety of software, firmware, processing thread(s) and/or subroutine(s). MAC 330 provides medium access controller (MAC) functionality and further implements, executes and/or carries out functionality to facilitate, direct and/or cooperate in avoiding avalanche effect. MAC 330 may be implemented by executing one or more of a variety of software, firmware, processing thread(s) and/or subroutine(s) with the example processor 320. Additionally or alternatively, MAC 330 may be implemented by hardware, software, firmware or a combination thereof.

Device 300 may also comprise at least one input device 380 (e.g., keyboard, touchpad, buttons, keypad, switches, dials, mouse, track-ball, voice recognizer, card reader, paper tape reader, etc.) and at least one output device 385 (e.g., liquid crystal display (LCD), printer, video monitor, touch screen display, a light-emitting diode (LED), etc.)—each of which are communicatively connected to interface 370.

Interface 370, additionally or alternatively, communicatively couples wireless modem 310 with processor 320 and/or MAC 330. Interface 370 enables interface to, for example and not by way of limitation, Ethernet cards, universal serial bus (USB), token ring cards, fiber distributed data interface (FDDI) cards, network interface cards, wireless local area network (WLAN) cards, etc. to enable device 300 to communicate with other devices and/or communicate via Internet 250 or at least one intranet. With such a network connection, processor(s) 320 may be able to receive information from at least one type of network technology, and/or output information to at least one type of network technology in the course of performing the herein-described processes. It should be appreciated that interface 370 may implement at least one of a variety of interfaces, such as an external memory interface, serial port, communication internal to device 300, general purpose input/output, etc.

Device 300 further comprises at least two dissimilar network technology subsystems 340. As a result, device 300 is said to have co-existing network technology. “Dissimilar” is used in this context to mean that at least one of the subsystems 340 implements an interface of a network technology or protocol different than another one of the subsystems 340. It should be understood that some embodiments of subsystems 340 may have their own dedicated wireless modem and antenna, while other embodiments may share either or both of a wireless modem and antenna. Embodiments of device 300 comprise at least two wireless network technology subsystems 340. FIG. 3 illustrates network technology subsystems 340A-340N, where N=the number network technology subsystems in device 300. Examples of network technologies that may be represented by such subsystems include, but are not limited to, worldwide interoperability for microwave access (WiMAX) networks, wireless local area network (WLAN) networks, WiFi, long term evolution (LTE) mobile telephony networks, personal area networks (PANs), wireless universal serial bus (USB) networks, BLUETOOTH (BT) networks, etc. Processor 320 interacts with network technology subsystems 340 via corresponding interfaces 470A-470N (see FIG. 4) implemented by interface 370. It should be appreciated that, although two or three such network technologies are discussed in connection with embodiments described below, in other embodiments more or fewer such technologies may be onboard a single device, and that the present teachings apply equally thereto.

Before proceeding further, it should be understood that, for ease of understanding, some embodiments are described herein in connection with a single lower priority technology network and a single higher priority technology network. However, these embodiments should in no way be considered limited to just these two onboard technology network subsystems. In some embodiments, there may be additional and/or different onboard technology network subsystems. In some embodiments, there may be at least one lower priority technology network (e.g., WLAN, etc.) and a plurality of higher priority technology networks (e.g., BT, WiMAX, etc.). It should be appreciated that the scope of this specification is not intended to be constrained to a single lower priority technology network and a single higher priority technology network onboard a device.

As illustrated in FIG. 4, device 410 comprises a controller 420 and interfaces 470A-470N, where N=the number of onboard network technologies corresponding to each of the respective dedicated interfaces. Controller 420, in turn, comprises monitor 430, calculator 440, timer 450, and scheduler 460. It should be appreciated that although the example device of FIG. 4 illustrates controller 420 as comprising, monitor 430, calculator 440, timer 450, and scheduler 460, one or more of these elements may be external to controller 420. Moreover, it should also be appreciated that, in many embodiments, controller 420 also comprises additional functionality such as security inputs (often from a user), managing power saving features for the interfaces, etc. Embodiments of device 410 may include wireless and, in some cases, wired links. Because at least some of the links are wireless, some communications may interfere with each other. For example, it may not be possible for two links to be active at the same time because the transmission of one would interfere with the transmission of the other. Accordingly, time-division multiplexing may be used such that interfering links may operate at different times, and embodiments of scheduler 460 may be configured with the priority and parameters of each onboard network technology, as well as any negotiated parameters established during initial association with an AP.

Controller 420 schedules the duration each active network traffic flow may keep priority on device 410's resources. There are a variety of scheduling options, one of which may be fair allocation. Generally, the device alternates among the various active traffic flows (corresponding to each of the initiated network technology subsystems represented on device 410) depending upon each service/traffic flow's priority as determined by scheduler 460. Each network preferably takes sequential turns in using device 410's resources to send packets to, or otherwise communicate with, networks outside of device 410. Scheduler 460 may establish a periodic transmission time for each onboard technology network subsystem, for improved and efficient use of device 410's resources. These periodic transmission(s) may also be provided to the AP(s) within any particular network to enable network-specific transmissions by the AP(s) during known network-specific active modes (reception) intervals.

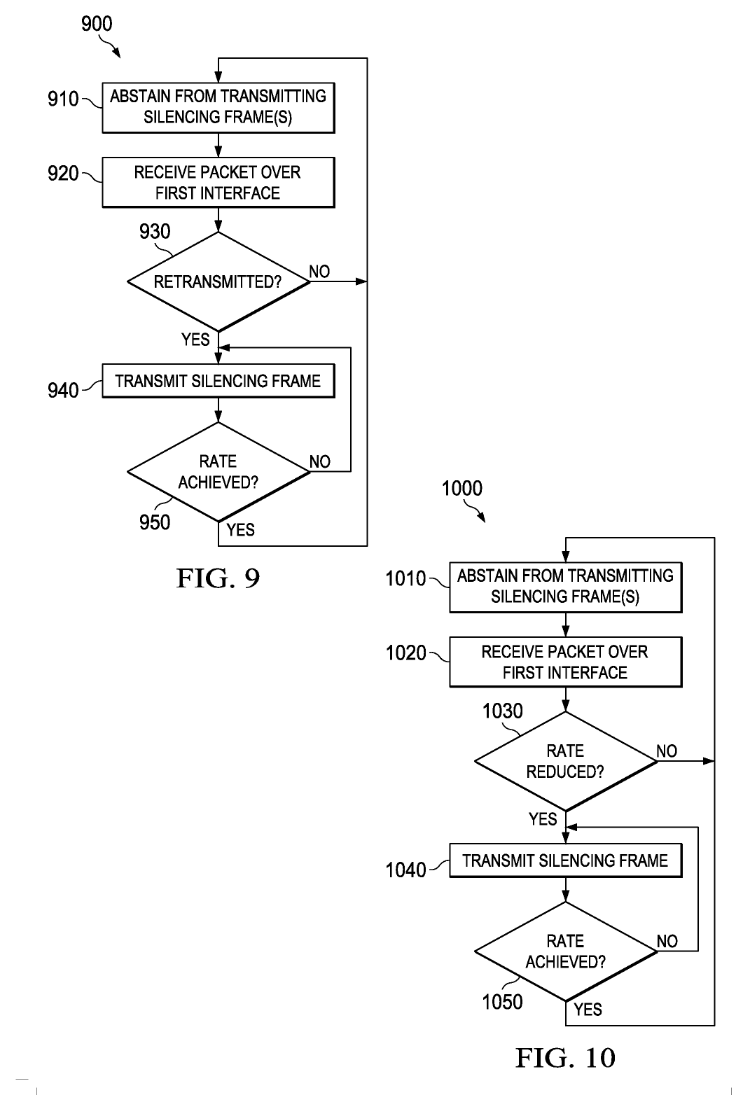

In some embodiments, scheduler 460 may be configured to transmit silencing frames when triggered by certain predetermined events. For instance, in some embodiments, scheduler 460 may transmit a silencing frame if: (a) a retransmitted packet has been received (e.g., as shown in FIG. 9), (b) a transmission rate falls has been reduced (e.g., as described in FIG. 10), and/or (c) an expected packet has not been received (e.g., as in FIG. 10). Otherwise, scheduler 460 may abstain or refrain from sending such frames. For example, in the absence of at least one of predetermined events (a)-(c), scheduler 460 may allow device 410 to switch operation between a first and second interfaces one or more times without transmitting silencing frames.

Upon detection of a predetermined event, however, scheduler 460 may be configured to transmit a silencing frame during the period of Δt until the start of higher priority active mode interval (if it can), otherwise no silencing frame is to be transmitted. Once the higher priority active mode interval has ended, and a lower priority active mode has begun, scheduler 460 may again attempt to transmit a silencing frame during the period of Δt (as determined by calculator 440) until start of higher priority active mode interval. As before, if the silencing frame cannot be transmitted prior to the start of the next immediate interval for higher priority active mode, no further effort is made to transmit a silencing frame. In some cases, this process may be repeated so long as higher priority active mode intervals continue to be scheduled.

Controller 420 calls monitor 430 to monitor traffic flow. In some embodiments, monitor 430 may monitor the existence of active traffic flows onboard device 410, while in other embodiments, monitor 430 may also monitor what network technology (e.g., WLAN, BT, WiMAX, etc.) and what type of transmission (e-mail, streaming video, VoIP, etc.) are affected. It should be appreciated that the various techniques described herein may involve any traffic flows regardless of type of traffic or whether the traffic is unicast, broadcast, multicast, etc.

Additionally, in at least some embodiments, controller 420 may employ monitor 430 to track changes in the active traffic flows. If monitor 430 determines that there has been a change in at least one of the active traffic flows, it also identifies the change. As one example, and not by way of limitation, a WLAN MAC sends a trigger to controller 420 indicating that it wants to add traffic (i.e., initiate a traffic flow). Embodiments of scheduler 460 dynamically focus on scheduling and prioritizing among the service calls (requests) based on the information gathered by monitor 430.

Embodiments of calculator 440 may perform various calculating operations, including, but not limited to, determining Δt to be used by scheduler 460. Calculator 440 employs timer 450, as well as registers, to establish the transit time(s) between AP and STA (device 410 in FIG. 4). At least some embodiments of calculator 440 may calculate the Δt time interval as follows:

Δt=max_{—}i(AP_to_{—}STA1_{—}Tx_Time+STA1_to_AP_{—}Tx_Time)

where “i” is the traffic flow indication from the AP to the STA and the latest duration values for each traffic flow duration are used to select the maximum value.

It should be appreciated that the time taken to transmit the silencing frame (e.g., CTS-to-self frame, in the present example) and, in some embodiments, the trigger frame (e.g., trigger frame-ACK, in the present example) from STA to the AP can be calculated because the STA device is the one initiating the transmission. Moreover, the time that the AP takes to transmit to the STA device can also be estimated from earlier transmissions, or may be a negotiated maximum transmitted size from the AP to STA in view of their negotiated data rates upon initial association. It should be appreciated that if the time the AP takes to transmit to the STA device is estimated from previous transmissions, the data rate and packet size from the most recent received transmission may be selected as the parameters from which to determine the AP to STA transmission time. Moreover, if there are multiple active traffic flows from AP to STA (e.g., belonging to different categories that may have different data rates and different packet sizes), because the STA will not know what the AP will send in response to the STA device's silencing frame, at least some embodiments of STA device may choose the maximum transmission time (data rate×packet size) among the transmission times most recently received with respect to each of the multiple active traffic flows.

It also should be appreciated that, in some embodiments, the maximum duration among the earlier transmissions may be selected. In at least some embodiments, the time to transmit the silencing frame (plus trigger frame, depending upon embodiments) plus time the AP takes to transmit to the STA equals Δt. It should be further appreciated that, once either parameter (i.e., data rate and/or data packet size) has been calculated, it may be stored in memory or a hardware register to be used in future determinations of preferred time for transmission of a silencing frame, including use for comparisons among respective parameter values to ascertain quality of medium, etc.

Calculator 440 may add the established transit time(s) (i.e., Δt) to the duration of the at least one higher priority interval to be protected to determine a duration (value). In some embodiments, calculator 440 may also subtract the determined duration from the known ending time of the at least one higher priority interval to be protected, and may identify the resulting time as the time for transmission of a silencing frame; which may then be provided to scheduler 460. In other embodiments, calculator 440 may subtract Δt from the known beginning time of the next immediate at least one higher priority interval to be protected, and may identify the resulting time as the preferred time for transmission of a silencing frame; also providing the resulting time to scheduler 460.

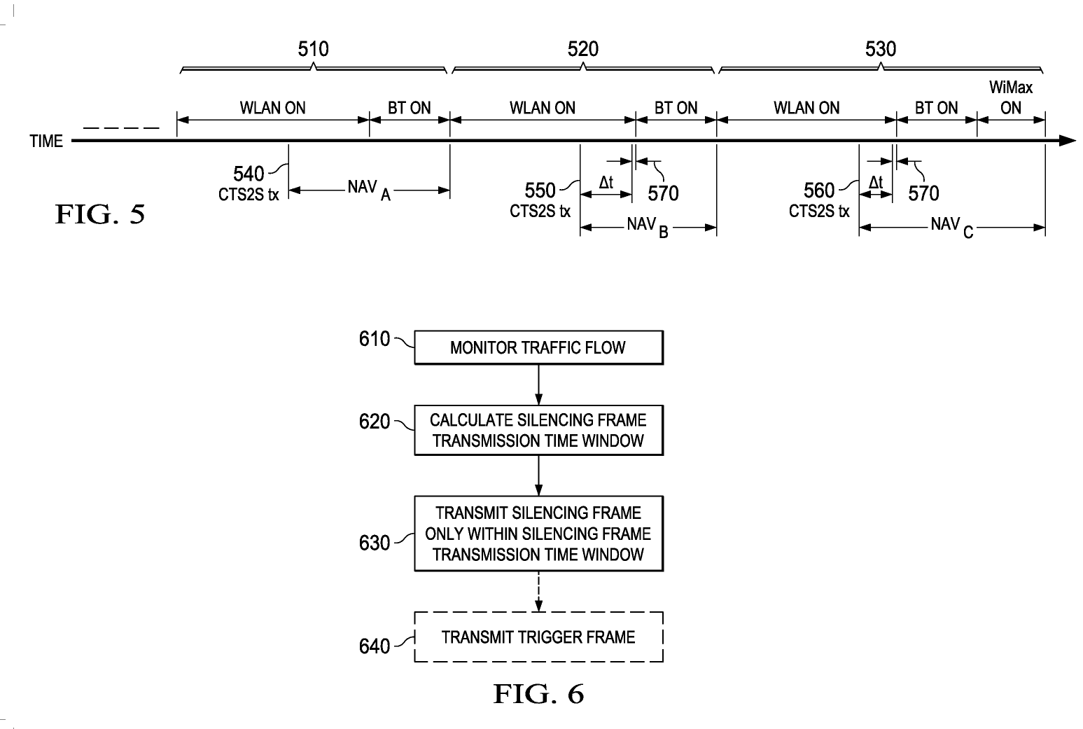

Scheduler 460 may direct controller 420 to transmit a silencing frame (e.g., CTS2S frame) at the resulting time. The resulting time may occur Δt prior to the beginning edge of BT active mode (FIG. 5). It should be noted that “Δt” is used to refer to the amount of time (a value) prior to the next immediate higher priority technology network active mode interval during which it is preferred for the device to transmit a silencing frame. As explained above, if controller 420 (via scheduler 460) is unable to transmit a silencing frame during the Δt period of time, then no silencing frame is sent with respect to the next immediate higher priority active mode interval.

Calculator 440 may also determine the end time of the predetermined transmission window by subtracting the time it takes to at least completely transmit the silencing frame from the known beginning time of the next immediate at least one higher priority interval to be protected; calculator 440 identifies the resulting time as the ending time of the predetermined transmission window. By determining the ending time of the transmission window, scheduler 460 may direct controller 420 to complete the transmission of the silencing frame in sufficient time prior to the beginning of the interval(s) to be protected (assuming the medium is not busy). If the medium is busy so that the transmission of the silencing frame cannot be completed prior to the beginning of the interval(s) to be protected (i.e., within the beginning and ending times of the predetermined transmission window), then scheduler 460 directs controller 420 to not send a silencing frame, and device/STA 410 transitions to the first of the next immediate at least one higher priority active modes.

It should also be appreciated that a silencing frame cannot be transmitted if the medium is busy (and that if the medium is not busy, the frame is transmitted). However, if the medium is busy, STA will wait until the medium becomes idle again before attempting to transmit the silencing frame. If the medium does not become idle again before the beginning of the next immediate higher priority active mode interval, controller 420 will not send a silencing frame.

On the other hand, if the silencing frame can be transmitted before the start of higher priority (e.g., BT) activity interval, i.e., sometime during the Δt period of time, then the network allocation vector (NAV) or duration is shortened to accommodate the remaining duration of Δt transmission window plus the duration of the at least one higher priority technology network active mode interval (e.g., ending of interval entitled “BT ON” in interval 520 or ending of interval entitled “WiMAX ON” in interval 530, both of FIG. 5). In other words, the value of NAV set at the beginning of Δt transmission window as calculated by calculator 440 is correspondingly reduced by the amount of time the medium remains busy after the maximum preferred frame transmission time has passed.

During certain intervals, a STA device participates in lower priority technology (WLAN) network, while during other intervals, it participates in higher priority technology networks (BT and WiMAX). In order to avoid the avalanche effect, and upon the occurrence of particular events, a silencing frame (e.g., a CTS-to-self frame) may be transmitted to the AP (from STA). If the silencing frame transmitted is a clear-to-send-to-self frame, it may be followed by a trigger frame (e.g., a PS-Poll or a quality of service (QoS) Nul frame) indicating to the AP that STA is ready to receive data packets. The silencing frame (in this example, a CTS-to-self frame and subsequent consecutive trigger frame) may include a network allocation vector (NAV) set to protect any higher priority technology network (in these examples, BT (interval 520) or BT and WiMAX (interval 530)) active mode period. Thus, the NAV is set to decrement until reaching the zero value at the ending of the higher priority active mode operation duration (which duration may encompass the total duration of more than one higher priority technologies' active modes). All other devices on the particular corresponding technology network, in this example WLAN, defer while their respective NAVs also decrement. Once a deferring device's NAV decrements to zero, the device no longer defers from accessing the medium, or sensing the medium to determine whether the medium is available. Hence, during the time identified in the transmitted silencing frame, no other WLAN STA can transmit or receive from the AP. However, as noted above, the time at which a silencing frame is sent impacts the WLAN performance. To improve WLAN throughput, it is preferred that the silencing frame is not sent until Δt time interval before the start of the next immediate higher priority (e.g., BT, WiMAX, etc.) period.

It should be appreciated that what is being referred to herein as a silencing frame may, in some embodiments, comprise more than one transmitted frame (e.g., such as a Clear-to-Send-to-Self frame immediately followed with a trigger frame). In such embodiments, the trigger frame is sent to prevent the other devices on the particular network from assuming that the original Clear-to-Send message was unsuccessful and begin to try to access the medium. However, once the trigger frame follows the Clear-to-Send frame, the other devices on the particular network set their respective NAV to the duration specified in the Clear-to-Send-to-Self frame, and defer until their respective NAV decrements to zero before again attempting to access the medium.

Furthermore, at least some embodiments enable transmission of a silencing frame from STA to take precedence by enabling STA to transmit a silencing frame after point coordination function interframe spacing (PIFS) time interval that the medium is idle. Thus, instead of waiting the customary distributed inter frame space (DIFS) interval before trying to gain access to the medium, it is preferred that the STA waits a PIFS interval before trying to gain access to the medium.

FIG. 5 is a timing diagram comparing times for sending silencing frames upon detection of a predetermined event, according to some embodiments. Actual detection of these predetermined events is discussed below with respect to FIGS. 9-11. Once such an event is detected, however, the times for sending silencing frame(s) are shown in FIG. 5. As illustrated, in each of intervals 510, 520, and 530, the STA device completes at least one higher priority network active mode and at least one lower priority network active mode. The timing diagram illustrates the timing of transmission of three silencing frames, under three different scenarios.

In interval 510, the silencing frame is randomly transmitted prior to the start of the high priority active mode operation interval. Specifically, the first frame is sent during interval 510 by STA at a random time at any time during the lower priority active mode interval (WLAN ON, in this example). The second frame is sent during interval 520 by STA at a first calculated time, and the third frame is sent during interval 530 by STA at another calculated time. Each calculated time may be determined by at least some embodiments as described herein. FIG. 5 corresponds to a device STA that alternates between at least two dissimilar network technologies. As noted above, however it should be understood that embodiments of the device may switch among more than two dissimilar network technologies.

Specifically, there are three intervals (510, 520, 530) illustrated, each comprising at least one higher priority active mode interval (BT active mode ON and/or WiMAX active mode ON) and one lower priority active mode interval (WLAN active mode ON). In intervals 510 and 520, STA reserves the medium until the end of the BT active mode (ending of interval entitled “BT ON” in FIG. 5) in exemplary interval 520. It should be understood that, although the silencing frame of transmissions 540, 550, and 560 are illustrated as “CTS2S tx” (clear-to-send-to-self transmission), other types of silencing frames may be used instead.

Within interval 510, STA device transmits a silencing frame 540 with duration information for all interested devices to set their NAVs equal to the value of NAV_{A}. It may be seen that there is no Δt in the interval bounded by NAV_{A}. It should be understood that the transmission 540 of a silencing frame occurs randomly at any time within the lower priority technology active mode (e.g., “WLAN ON” in the present example). The time to transmit silencing frame is not predetermined or calculated to be at a specific time. Once it is sent, all interested devices on the respective network set their NAVs to the value corresponding to NAV_{A}. Because the timing of transmission 540 is random at any time within the lower priority technology active mode, transmission 540 regularly (and unnecessarily) ties up network resources, which are obliged to defer until their respective NAVs have completely decremented.

Within interval 520, STA device transmits a silencing frame 550 with duration information for all interested devices to set their NAVs equal to the value of NAV_{B}. However, according to some embodiments, the silencing frame may only be sent by the STA during the predetermined transmission window identified in interval 520 by “Δt”. As noted above, Δt transmission window is determined to preferably minimize the amount of time the STA device ties up corresponding technology network resources. The transmission 550 of silencing frame may occur at any time during the predetermined Δt transmission window, depending upon whether the medium is busy, and in some embodiments, whether the STA waits PIFS instead of DIFS after the medium becomes available to transmit. If the medium is not busy, the STA may transmit the silencing frame as close to the beginning of the predetermined Δt transmission window as possible. If STA cannot transmit the silencing frame during the Δt transmission window, it will not transmit a silencing frame at all to protect the upcoming higher priority technology active mode (e.g., “BT ON”, in the present illustration).

Within interval 530, STA device transmits a silencing frame 560 with duration information for all interested devices to set their NAVs equal to the value of NAV_{C}. However, according to embodiments, the silencing frame may only be sent by the STA during the transmission window identified in interval 530 by “Δt”. As with the embodiment of interval 520, Δt transmission window of interval 530 is determined to preferably minimize the amount of time the STA device ties up corresponding technology network resources. Again, the transmission 560 of a silencing frame may occur at any time during the Δt transmission window, depending upon whether the medium is busy, and in some embodiments, whether the STA waits PIFS instead of DIFS after the medium becomes available to transmit. If the medium is not busy, the STA may transmit the silencing frame as close to the beginning of the predetermined Δt transmission window as possible. If STA cannot transmit the silencing frame during the Δt transmission window, it will not transmit a silencing frame at all to protect the at least one upcoming higher priority technology active mode(s) (e.g., “BT ON” and “WiMAX ON”, in the present illustration).

It should be noted that the Δt transmission window ends prior to the beginning of the next immediate string of at least one higher priority technology network active modes in intervals 520 (“BT ON”) and 530 (“BT ON and WiMAX ON”), respectively. The silencing frame transmission gap 570 shown in each interval (520, 530) illustrates the time it takes to complete transmission of the silencing frame. In some embodiments, gap 570 also includes time for response from another device on the network and/or the time required for the device to switch from one network to the other. In some implementations, the transmission of the silencing frame may start during the Δt transmission window. Moreover, if the transmission of the silencing frame is started just prior to the end of the Δt transmission window, the transmission of the silencing frame may be completed prior to the commencement of the next immediate (imminent) string of at least one higher priority active modes.

In interval 530, however, STA reserves the medium until the end of the WiMAX active mode (ending of interval entitled “WiMAX ON” in FIG. 5). Thus, the STA device sends a CTS-to-self frame (example of a silencing frame) to protect all consecutive higher priority frames in the next immediate string of higher priority frames. In interval 530, STA device sends a silencing frame to protect the transmission from STA to AP, the acknowledgement from the AP to STA, the BT ON (active mode interval) and the WiMAX ON (active mode interval). It should be understood that additional higher priority technology networks may immediately follow the two illustrated in FIG. 5. In such embodiments, the STA may send a silencing frame at a time which will protect all such consecutive high priority network activity (active mode intervals). In other words, the duration field of the silencing frame may be set to protect a string of as many consecutive higher priority active modes as needed or desired for a given device.

FIG. 6 illustrates a method for communicating according to some embodiments. At block 610, the controller monitors traffic flow. Traffic flow monitored may comprise activity on the medium, as well as coordination of a device's shift between higher and lower priority active modes (e.g., on a predetermined alternation schedule, based on a detected incoming transmission addressed to the device, etc.). The controller calculates the duration, as well as timing, of a silencing frame transmission time window (block 620) and transmits a silencing frame only during the calculated window (block 630). In some embodiments, if the silencing frame was a clear-to-send-to-self frame, the device may immediately follow with a transmission of a trigger frame. Because the functionality of block 640 is optional—for example, it may not be used if the silencing frame transmitted by the device is not a clear-to-send-to-self frame—block 640 is shown in dashed outline.

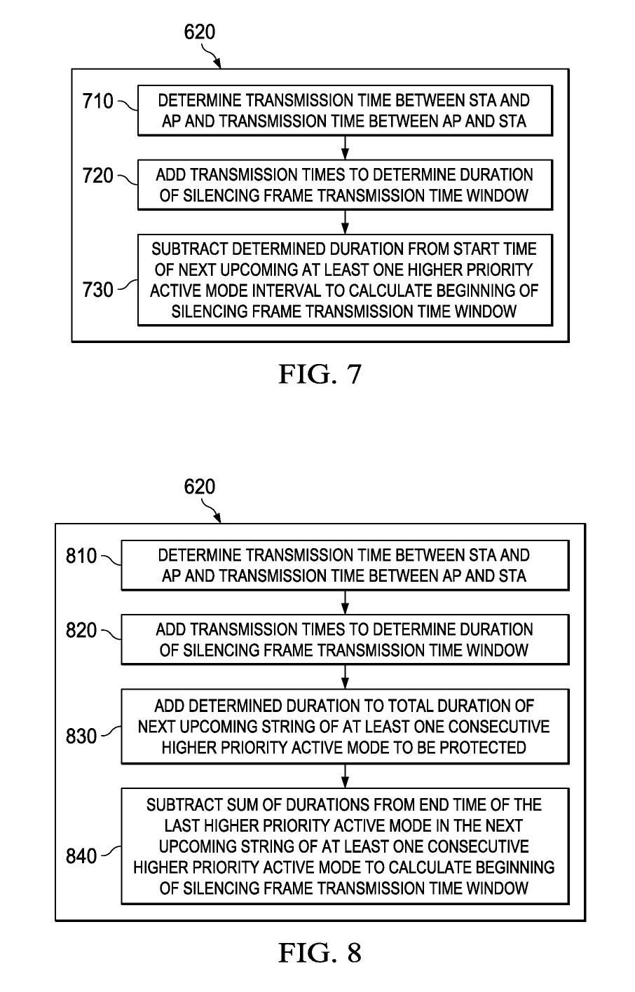

FIG. 7 illustrates an exemplary method of calculating a silencing frame transmission time window (block 620 of FIG. 6), according to embodiments. It should be understood that although block 620 of FIG. 7 is shown as comprising blocks 710, 720 and 730, block 620 may comprise additional blocks, or further combine those illustrated as desired. It should also be appreciated that any of the blocks 710, 720 and 730 may instead comprise a different element of a device.

At block 710, the transmission times from STA to AP and from AP to STA are determined. The transmission time from STA to AP can be determined because the transmission is from the STA. In some embodiments, the transmission times from the AP to STA are additionally or alternatively, measured and subsequently stored. The latest data rate and packet size are preferably selected to determine the transmission time from the AP to STA. The determined transmission times from AP to STA and STA to AP are added together (block 720) to determine the value of Δt, which is the duration of the silencing frame transmission time window. This value is subtracted (block 730) from the start time of the next immediate higher-priority technology subsystem network active mode to identify the Δt transmission window, which window bounds the time for STA to transmit a silencing frame to avoid avalanche effect while increasing network throughput. In some embodiments, the value of Δt may be subtracted from the start time of an immediately following string of consecutive higher-priority technology subsystem network active modes. In other embodiments, the value may be calculated and stored in advance, then retrieved when the next immediate lower priority active mode begins. It should be appreciated that it is intended that “string” as used herein shall mean one or more.

Returning to block 630 of FIG. 6, the STA may only transmit a silencing frame during the respective Δt transmission window to protect the upcoming at least one consecutive higher priority active modes. However, the STA device cannot transmit a silencing frame at all if the medium is busy. Thus, when the medium is busy, embodiments of STA device may defer and wait until the medium is not busy before transmitting a silencing frame. Thus, the STA's NAV may be set at the beginning of the respective Δt transmission window, and it may be decremented until the medium is free. Upon accessing the medium, the value of then-decremented NAV may then be transmitted as part of the silencing frame and follow-on trigger frame, if any.

FIG. 8 illustrates another exemplary method of calculating a preferred silencing frame transmission time (block 620 of FIG. 6), according to embodiments. It should be understood that although block 620 of FIG. 8 is shown as comprising blocks 810, 820, 830 and 840, block 620 may comprise additional blocks, or further combine those illustrated as desired. It should also be appreciated that any of the blocks 810, 820, 830 and 840 may instead comprise a different element of a device.

At block 810, the transmission times from STA to AP and from AP to STA are determined. The transmission time from STA to AP can be determined because the transmission is from the STA. In some embodiments, the transmission times from the AP to STA are additionally or alternatively, measured and subsequently stored. The latest data rate and packet size are preferably selected to determine the transmission time from the AP to STA. The determined transmission times from AP to STA and STA to AP are added together (block 820) to determine the value of Δt, which is the duration of the silencing frame transmission time window. This value is added (block 830) to the total duration of the immediately upcoming string of at least one consecutive higher priority active modes that are to be protected. It should be appreciated that the duration when a higher priority technology network is active (in active mode) may also be referred to herein as an interval. As an example, and not by way of limitation, the total duration of the immediately upcoming at least one string of consecutive higher priority active modes in interval 530 of FIG. 5 may be the total combined duration of the BT ON and WiMAX ON periods.

Returning to FIG. 8, the resulting sum from block 830 may be subtracted from the end time of the last higher priority active mode in the next immediate higher-priority technology subsystem network active mode (block 840) to identify the beginning of the Δt transmission window, which window bounds the time for STA to transmit a silencing frame to avoid avalanche effect while increasing network throughput. In some embodiments, the value may be calculated and stored in advance, then retrieved when the next immediate lower priority active mode begins.

It should be appreciated that the total duration to be protected by the silencing frame may include the sum of the duration remaining of the predetermined transmission time window interval after the time it takes to transmit the silencing frame and the duration of the immediately upcoming string of at least one consecutive higher priority active mode interval.

In some embodiments, various systems and methods described herein may also help reduce the number of transmitted silencing frames, and therefore improve the overall network throughput. As the inventors hereof have recognized, the use of silencing frames to protect higher priority network technologies (e.g., BT) and the avalanche effect characteristic of coexisting networks may reduce the throughput of lower priority network technologies (e.g., WLAN), especially if the transmission of silencing frames occurs every time the coexistence node (e.g., STA) switches its mode of operation from the a lower to a higher priority network technology. However, as the inventors hereof have further recognized, transmission of silencing frames may not always be necessary. Accordingly, in some embodiments, a coexistence node may transmit a silencing frame only upon detection of a predetermined event.

FIG. 9 is a flowchart of a method of reducing a number of silencing frames transmitted in a coexistence network. In some embodiments, STA 410 may perform method 900, for example. At block 910, STA 410 may abstain from transmitting silencing frames as its default operation. At block 920, STA 410 may receive a packet over a lower priority wireless interface or subsystem (e.g., WLAN).

If STA 410 identifies the received packet as a retransmitted packet (e.g., by examining a retransmission bit in the packet header) at block 930—i.e., a predetermined, triggering event—then STA 410 may infer that an original packet transmission has been lost due to STA410 operating over a higher priority interface (e.g., BT). Therefore, to protect from a potential additional loss of packets, STA 410 may send one or more silencing frames at block 940. Otherwise, control may return to block 910, where STA 410 maintains its default mode of operation where it refrains from transmitting silencing packets.

At block 950, STA 410 may optionally determine that a transmission rate is lower than a previously achieved rate based, at least in part, upon the received packet. If so, once a first silencing frame sending is triggered, then one or more additional silencing frames may be sent in block 940 until the original or maximum attainable physical rate between STA 410 and the AP is achieved.

In some embodiments, to gather statistics on the packet arrivals from the AP to STA 410, as well as on the maximum physical rate between STA 410 and the AP, STA 410 may be configured to operate in an investigation or observation mode, where it may observe the medium (e.g., one or more frequency bands) for some period of time while transmitting silencing frames. Once the observation time elapses, the statistics gathered may be taken as an indicator of packet arrival rates at STA 410 and the maximum attainable rate between STA 410 and the AP. After this investigation or observation period, STA 410 may again return to its default mode of operation where it abstains from sending silencing frames (block 910) unless a received packet (block 920) is identified as a retransmitted packet (block 930) or some other predetermined triggering event occurs.

FIG. 10 is a flowchart of another method of reducing a number of silencing frames transmitted in a coexistence network. In some embodiments, STA 410 may perform method 1000, for example. Moreover, operations 1010, 1020, 1040, and 1050 may be similarly implemented as operations 910, 920, 940, and 950, respectively. The predetermined, triggering event of FIG. 10 as shown in block 1030, however, is a determination or detection that a transmission or packet rate has been reduced, independently of whether the retransmission bit in the received packet has been set. A rate drop can result in an avalanche effect, because the next rate could be at an even lower rate if a silencing frame is not transmitted to protect from packet loss during the time that STA 410 operates in the higher priority (e.g., BT) mode.

As previously noted, STA 410 may operate in an investigation or observation period during which it may transmit silencing frames prior to every low-to-high priority interface transition in order to gather statistics or other information indicative of the maximum attainable rate between STA 410 and the AP. Thus, in some embodiments, STA 410 may determine a transmission or packet rate based on a presently received packet and may compare the present rate with the maximum attainable rate. If, at block 1030, STA 410 determines that the difference between the present rate and the maximum attainable rate meets a specified threshold value, STA 410 may then transmit one or more subsequent silencing frames to attempt to achieve or approach that maximum rate.

Additionally or alternatively, STA 410 may calculate or otherwise estimate the current transmission or packet rate and compare it with previously calculated or estimated rates based on other received packets. If the current rate displays a drop compared to previous rates (e.g., meeting a given threshold or tolerance value), block 1030 may also trigger the transmission of a silencing frame.

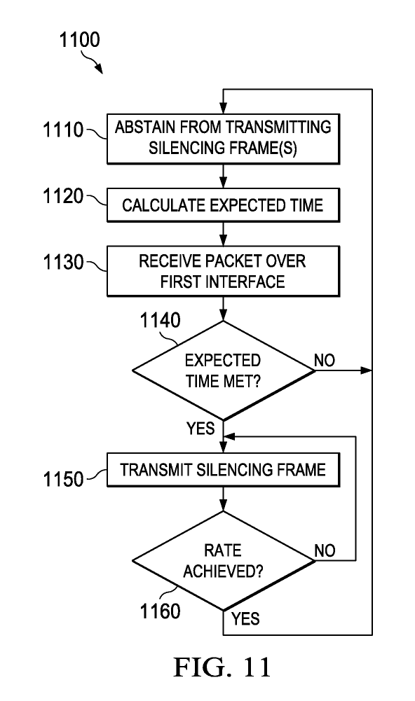

FIG. 11 is a flowchart of yet another method of reducing a number of silencing frames transmitted in a coexistence network. Again, in some embodiments, STA 410 may perform method 1100. Also, operations 1110, 1130, 1150, and 1160 may be implemented similarly as operations 910, 920, 940, and 950, respectively. The predetermined triggering event of FIG. 11 shown in block 1140, however, is a determination or detection that a given packet has not been received as expected (i.e., it has been missed by STA 410), independently of whether a transmission rate has been reduced and/or whether the retransmission bit in the received packet has been set.

To determine that the packet has been missed, at block 1120 STA 410 may examine traffic statistics collected during the investigation or observation period. A packet not arriving for some time may be used as an indicator that STA 410 is not receiving packets sent from the AP for example, because those packets arrive during a time when STA 410 is operating in a higher priority (e.g., BT) mode. Accordingly, at block 1150, STA 410 may transmit a silencing frame.

The systems and methods described above, particularly with respect to FIGS. 9-11, may help reduce the number of silencing frames transmitted in a coexistence network. Therefore, in some embodiments, silencing frames may be transmitted or sent only on an “as-needed” basis—i.e., upon detection of a predetermined event, which may potentially trigger an avalanche effect. In some cases, each predetermined event may be implemented separately or individually as shown in FIGS. 9-11.

For example, in some implementations, two or more predetermined events (e.g., 930/1030; 930/1140; 1030/1040; or 930/1030/1140) may be combined such that STA 410 may transmit a silencing frame when either of those two or more events takes place. For instance, when the two or more predetermined events are events 930 and 1030, the silencing frame may be transmitted when a retransmitted packet arrives or when a packet rate has dropped. In yet other implementations, STA 410 may transmit the silencing frame when all of the two or more events take place. For instance, when the two or more predetermined events are 1030 and 1140, STA 410 may transmit a silencing frame only when a transmission rate has dropped and an expected packet has not arrived. More generally, any suitable logical combination of these predetermined events may be used to trigger the transmission of one or more silencing frames (e.g., 930 AND 1030; 930 OR 1030; 930 AND 1140; 930 OR 1140; 1030 AND 1140; 1030 OR 1140; 930 AND 1030 AND 1140; 930 AND 1030 OR 1140; 930 OR 1030 AND 1140; 930 OR 1030 OR 1140). Furthermore, each of triggering events 930, 1030, and 1140 may be detected, calculated or otherwise determined in series or in parallel with respect to each other, and in any suitable order. For example, when implemented in series, event 1140 (i.e., missing packet) may only be detected (for purposes of determining whether to transmit a silencing frame) in response to a determination that event 1030 (i.e., packet rate has dropped) has already taken place (or vice-versa).

It will be understood that various operations discussed with respect to FIGS. 6-11 may be executed simultaneously and/or sequentially. It will be further understood that each operation may be performed in any order and may be performed once or repetitiously. In various embodiments, the modules shown in above may represent sets of software routines, logic functions, and/or data structures that are configured to perform specified operations. Although these modules are shown as distinct logical blocks, in other embodiments at least some of the operations performed by these modules may be combined in to fewer blocks. Conversely, any given one of these modules may be implemented such that its operations are divided among two or more logical blocks. Moreover, although shown with a particular configuration, in other embodiments these various modules may be rearranged in other suitable ways.

Many of the operations described herein may be implemented in hardware, software, and/or firmware, and/or any combination thereof. When implemented in software, code segments perform the necessary tasks or operations. The program or code segments may be stored in a processor-readable, computer-readable, or machine-readable medium. The processor-readable, computer-readable, or machine-readable medium may include any device or medium that can store or transfer information. Examples of such a processor-readable medium include an electronic circuit, a semiconductor memory device, a flash memory, a ROM, an erasable ROM (EROM), a floppy diskette, a compact disk, an optical disk, a hard disk, a fiber optic medium, etc.

Software code segments may be stored in any volatile or non-volatile storage device, such as a hard drive, flash memory, solid state memory, optical disk, CD, DVD, computer program product, or other memory device, that provides tangible computer-readable or machine-readable storage for a processor or a middleware container service. In other embodiments, the memory may be a virtualization of several physical storage devices, wherein the physical storage devices are of the same or different kinds. The code segments may be downloaded or transferred from storage to a processor or container via an internal bus, another computer network, such as the Internet or an intranet, or via other wired or wireless networks.

Many modifications and other embodiments of the invention(s) will come to mind to one skilled in the art to which the invention(s) pertain having the benefit of the teachings presented in the foregoing descriptions, and the associated drawings. Therefore, it is to be understood that the invention(s) are not to be limited to the specific embodiments disclosed. Although specific terms are employed herein, they are used in a generic and descriptive sense only and not for purposes of limitation.

1. A method comprising:
performing, by a wireless device,
receiving a packet over a first interface;
determining that the received packet is a retransmitted packet; and
transmitting a silencing frame in response to the determination, the silencing frame configured to reserve a frequency band for a specified time, the specified time beginning prior to the wireless device switching operation from the first interface to a second interface dissimilar from the first interface, the specified time ending when the wireless device switches operation back to the first interface.

2. The method of claim 1, further comprising:
performing, by the wireless device,
prior to receiving the packet over the first interface, abstaining from transmitting one or more silencing frames.

3. The method of claim 1, further comprising:
performing, by the wireless device,
prior to receiving the packet over the first interface, switching operation between the first and second interfaces at least once without transmitting one or more silencing frames.

4. The method of claim 1, wherein the silencing frame includes a clear-to-send (CTS)-to self frame.

5. The method of claim 4, wherein the silencing frame includes a trigger frame following the CTS-to-self frame.

6. The method of claim 1, wherein the frequency band spans a frequency of operation of the first interface.

7. The method of claim 1, wherein the frequency band spans a frequency of operation of the second interface.

8. The method of claim 1, wherein the frequency band spans a frequency of operation of the first and second interfaces combined.

9. The method of claim 1, further comprising:
performing, by the wireless device,
determining that a specified transmission rate between an access point and the wireless device has not been achieved; and
transmitting another silencing frame prior to the wireless device switching operation from the first interface to the second interface in response to the latter determination.

10. The method of claim 8, wherein the specified transmission rate is calculated based, at least in part, upon packet arrival rates obtained by the wireless device when transmitting silencing frames.

11. The method of claim 1, further comprising:
performing, by the wireless device,
receiving another packet over the first interface;
determining that a transmission rate has been reduced based, at least in part, upon the another packet; and
transmitting another silencing frame in response to the latter determination.

12. The method of claim 1, further comprising:
performing, by the wireless device,
calculating an expected time when another packet is expected to be received over the first interface;
determining that the another packet has not been received by the expected time; and
transmitting another silencing frame in response to the latter determination.

13. A wireless communication device comprising:
a processor; and
a memory coupled to the processor, the memory configured to store program instructions executable by the processor to cause the wireless communication device to:
receive a first packet over a first interface;
determine that a transmission rate has been reduced based, at least in part, upon the first packet; and
transmit a silencing frame in response to the determination, the silencing frame configured to reserve a frequency band for a specified time, the specified time beginning prior to the wireless device switching operation from the first interface to a second interface dissimilar from the first interface, the specified time ending when the wireless device switches operation back to the first interface.

14. The wireless communication device of claim 13, the program instructions executable by the processor to cause the wireless communication device to:
prior to receiving the packet over the first interface, switch operation between the first and second interfaces at least once without transmitting one or more silencing frames.

15. The wireless communication device of claim 14, the program instructions executable by the processor to cause the wireless communication device to:
receive a second packet over the first interface;
determine that the second packet is a retransmitted packet; and
transmit a second silencing frame in response to the latter determination.

16. The wireless communication device of claim 15, the program instructions executable by the processor to cause the wireless communication device to:
calculate an expected time when a third packet is expected to be received over the first interface;
determine that the third packet has not been received by the expected time; and
transmit a third silencing frame in response to the latter determination.

17. A tangible electronic storage medium having program instructions stored thereon that, upon execution by a processor within a wireless communication device, cause the wireless communication device to:
calculate an expected time when a first packet is expected to be received over a first interface;
determine that the first packet has not been received by the expected time; and
transmit a silencing frame in response to the determination, the silencing frame configured to reserve a frequency band for a specified time, the specified time beginning prior to the wireless device switching operation from the first interface to a second interface dissimilar from the first interface, the specified time ending when the wireless device switches operation back to the first interface.

18. The tangible electronic storage medium of claim 17, wherein the program instructions, upon execution by the processor, further cause the wireless communication device to:
prior to receiving the first packet over the first interface, refraining from transmitting one or more silencing frames.

19. The tangible electronic storage medium of claim 18, wherein the program instructions, upon execution by the processor, further cause the wireless communication device to:
receive a second packet over the first interface;
determine that the second packet is a retransmitted packet; and
transmit a second silencing frame in response to the latter determination.

20. The tangible electronic storage medium of claim 19, wherein the program instructions, upon execution by the processor, further cause the wireless communication device to:
receive a third packet over the first interface;
determine that a transmission rate has been reduced based, at least in part, upon the third packet; and
transmit a third silencing frame in response to the latter determination.
